(19) United States
(12) Patent Application Publication
(10) Pub. No.: US 2012/0298058 A1
(43) Pub. Date: Nov. 29, 2012

(54) SYSTEM FOR ATTACHING A CAMSHAFT PHASER TO A CAMSHAFT

(75) Inventors: THOMAS H. FISCHER, ROCHESTER, NY (US); THOMAS H. LICHTI, VICTOR, NY (US)

(73) Assignee: DELPHI TECHNOLOGIES, INC., TROY, MI (US)

(21) Appl. No.: 13/117,740

(22) Filed: May 27, 2011

(51) Int. Cl. F01L 1/344; B23P 19/00

(52) U.S. Cl. 123/90.15; 29/700

(57) ABSTRACT

A camshaft phaser attachment system is provided for attaching a camshaft phaser to a camshaft of an internal combustion engine. The camshaft phaser attachment system includes a camshaft phaser for controllably varying the phase relationship between a crankshaft and the camshaft. The camshaft phaser attachment system also includes a camshaft phaser installation tool having a handle with a head sized to be inserted through an opening of a cover of the camshaft phaser. A plurality of notches formed on a rotor of the camshaft phaser interfit with a plurality of tangs of the head. The head includes a recess on the periphery to provide clearance relative to a bias spring capture flange extending radially inward from the opening. The head also includes a central passage extending through the head to allow a tightening tool to tighten a bolt used to hold the camshaft phaser to the camshaft.

### TECHNICAL FIELD OF INVENTION

The present invention relates to a hydraulically actuated camshaft phaser for varying the phase relationship between a crankshaft and a camshaft in an internal combustion engine; more particularly to such a camshaft phaser that is a vane-type camshaft phaser, and more particularly to a system for attaching such a vane-type camshaft phaser to a camshaft of an internal combustion engine.

### BACKGROUND OF INVENTION

Vane-type camshaft phasers are well known in the internal combustion engine art for varying the phase relationship between a camshaft and a crank shaft of an internal combustion engine. When the internal combustion engine is in operation, the camshaft phaser allows the phase relationship between the camshaft and the crank shaft to be varied in order to achieve desired operating performance of the internal combustion engine. Vane-type camshaft phasers are typically attached to the camshaft of the internal combustion engine by using a camshaft phaser attachment bolt such that a shank of the camshaft phaser attachment bolt passes coaxially through the camshaft phaser and threadably engages the camshaft. After the camshaft phaser attachment bolt is tightened, the camshaft phaser is clamped axially between the head of the camshaft phaser attachment bolt and the camshaft. In order to tighten the camshaft phaser attachment bolt, the camshaft must be restrained from rotating. This is typically accomplished by using a wrench to engage opposing flats faces on the camshaft. The wrench is held substantially stationary while the camshaft phaser attachment bolt is tightened to a predetermined torque. This method of attaching the camshaft phaser to the camshaft is satisfactory, however, some internal combustion engines include valve train elements, such as two-step roller finger followers, that do not allow sufficient space to include opposing flat surfaces on the camshaft.

One such camshaft phaser attachment system which does not require opposing flat surfaces in order to restrain the camshaft while the camshaft phaser attachment bolt is being tightened to the predetermined torque is shown in U.S. Pat. No. 7,004,129 and German Patent Application Publication Nos. DE 10 2007 039 282 A1 and DE 10 2004 035 007 A1. In this system, the camshaft phaser includes an extension to the rotor which protrudes through an opening of a camshaft phaser cover which seals one axial end of the advance and retard chambers. A bias spring is wound around the extension such that one end of the bias spring is grounded to the stator of the camshaft phaser while a second end is attached to the extension. In this way the bias spring positions the rotor within the stator to a predetermined position when pressurized oil is not supplied to the camshaft phaser. The extension includes opposing notches which are used to engage tangs of a camshaft phaser installation tool while the camshaft phaser attachment bolt is tightened to the predetermined torque. The camshaft phaser installation tool substantially prevents rotation of the camshaft while the camshaft phaser attachment bolt is tightened to the predetermined torque.

While this arrangement for tightening the camshaft phaser bolt may be satisfactory for camshaft phasers with an extension which extends axially outward from the camshaft phaser cover, this camshaft installation tool may not work satisfactorily with camshaft phasers that include the bias spring axially between the camshaft phaser cover and the rotor because the rotor does not include an extension extending axially outward of the camshaft phaser cover and the camshaft phaser cover and bias spring may obstruct the camshaft phaser attachment tool from passing through the opening.

What is needed is a system for attaching a camshaft phaser with a bias spring positioned axially between the camshaft phaser cover and the rotor to a camshaft. What is also needed is such a system which does not require opposing flat surfaces on the camshaft in order to restrain the camshaft while the camshaft phaser attachment bolt is tightened to a predetermined torque. What is also needed is such a system which retrains the camshaft by using features on the rotor and a tool adapted to pass through an opening in the camshaft phaser cover.

### SUMMARY OF THE INVENTION

Briefly described, a camshaft phaser attachment system is provided for attaching a camshaft phaser to a camshaft. The camshaft phaser attachment system includes a camshaft phaser for controllably varying the phase relationship between a crankshaft and a camshaft in an internal combustion engine. The camshaft phaser includes a stator attached to the engine crankshaft to provide a fixed ratio of rotation therebetween. A rotor of the camshaft phaser has a central hub and is disposed within the stator as to form an array of pressurized oil chambers used to vary the phase relationship between the crankshaft and the camshaft. The rotor is attachable at the central hub to the camshaft of the internal combustion engine to prevent relative rotation between the rotor and the camshaft. The central hub includes a plurality of angularly spaced notches therein. A camshaft phaser attachment bolt extends coaxially through the central hub to threadably engage the camshaft to clamp the rotor to the camshaft. A camshaft phaser cover is engageable with the stator to seal one side of the pressurized oil chambers and has a central opening to provide access to the central hub. The central opening is defined by a semi-circular inner edge and an arcuate spring capture flange extending radially inwardly from the inner edge. A helical bias spring is contained axially between the camshaft phaser cover capture flange and the rotor to bias the rotor to a predetermined position when pressurized oil is not supplied to the pressurized chambers.

The camshaft phaser attachment system also includes a camshaft phaser installation tool. The camshaft installation tool includes a handle with a head sized to be inserted through the central opening of the camshaft cover and to be held substantially stationary while the camshaft phaser attachment bolt is being tightened to the predetermined torque. The head includes a recess in the outer periphery to provide clearance relative to the spring capture flange. The head also includes a plurality of tangs sized to interfit closely with the rotor notches and prevent relative rotation with the rotor. A substantially cylindrical central passage extends through the head of the handle to allow a tightening tool to reach the camshaft phaser attachment bolt for tightening the camshaft attachment bolt to the predetermined torque.

Further features and advantages of the invention will appear more clearly on a reading of the following detail description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is an exploded isometric view of a camshaft phaser attachment system in accordance with the present invention;

FIG. 2 is an axial cross-section of the camshaft phaser attachment system of FIG. 1;

FIG. 3 is an isometric radial cross-section of a camshaft phaser in accordance with the present invention taken along section line identified by arrows 3 in FIG. 2; and

FIG. 4 is an enlarged isometric view of a camshaft phaser attachment tool of the camshaft phaser attachment system of FIG. 1.

### DETAILED DESCRIPTION OF INVENTION

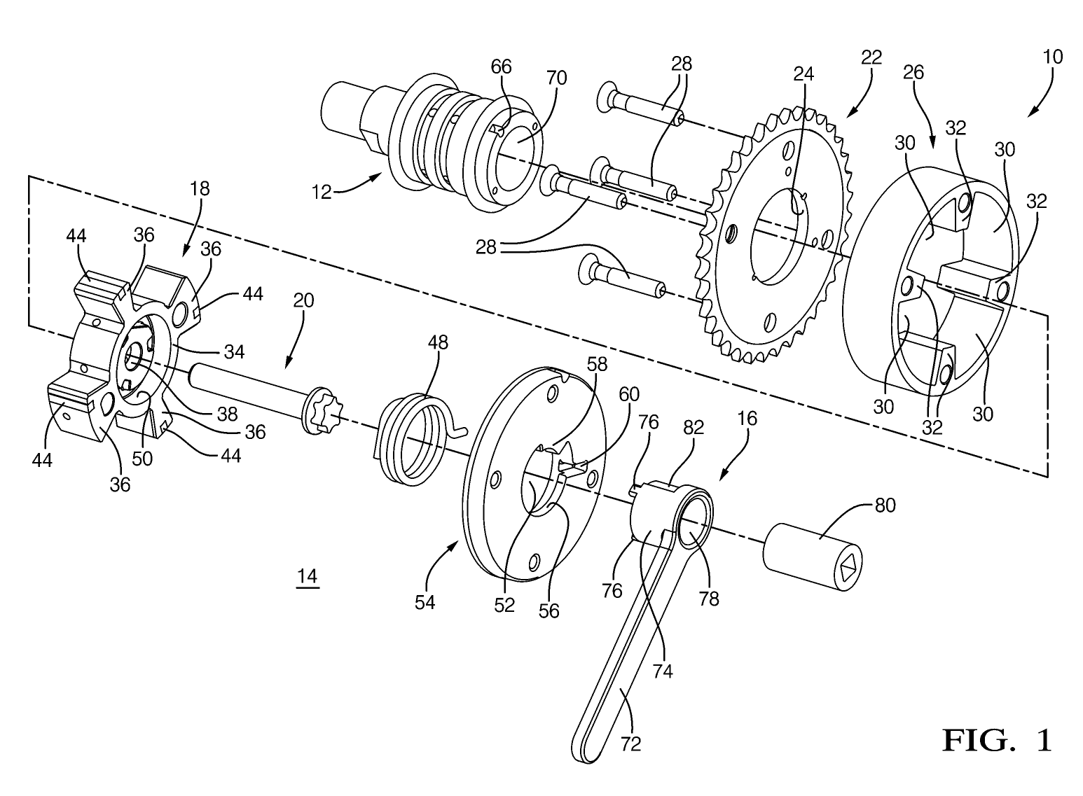

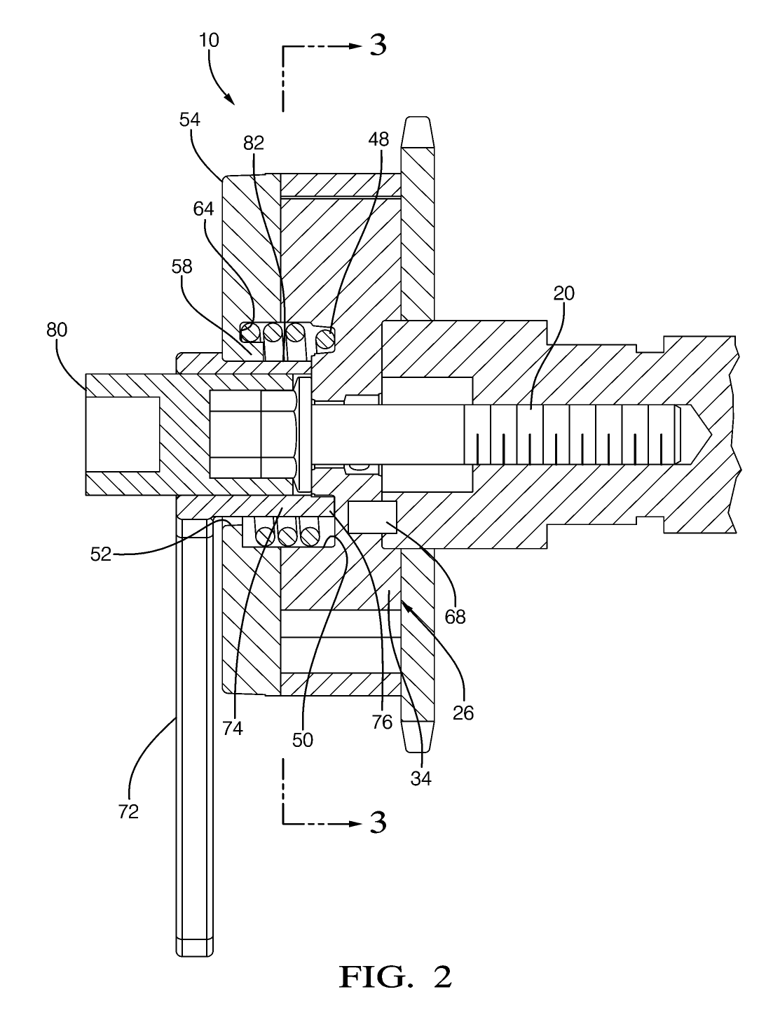

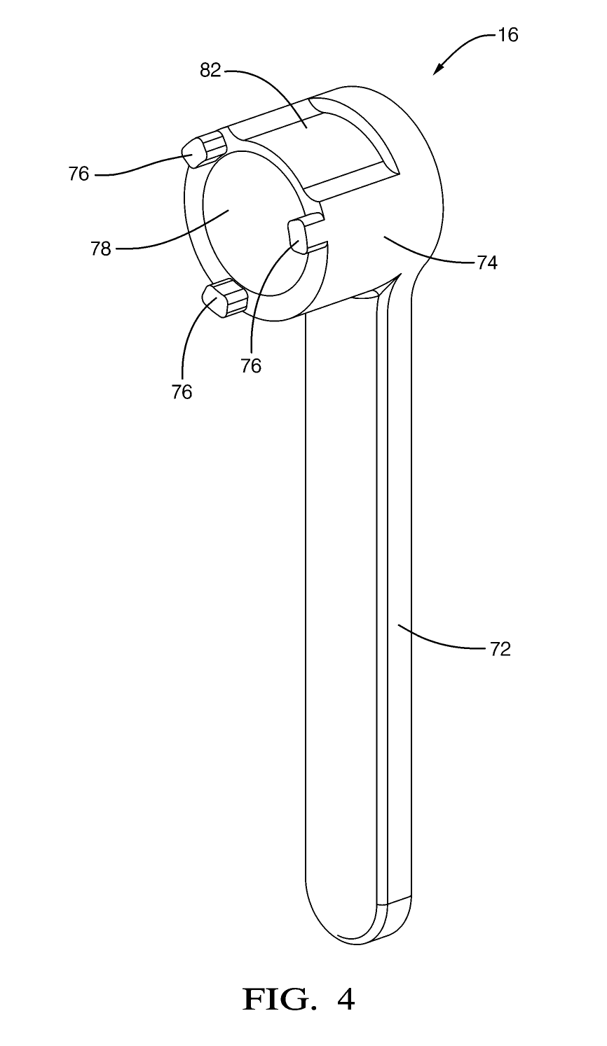

In accordance with a preferred embodiment of this invention and referring to FIGS. 1-4, a system for attaching camshaft phaser 10 to camshaft 12 of internal combustion engine 14 is shown. Camshaft 12 is rotatable based on rotational input from a crankshaft and chain (not shown) driven by a plurality of reciprocating pistons (also not shown). As camshaft 12 is rotated, it imparts valve lifting and closing motion to intake and/or exhaust valves (not shown) as is well known in the internal combustion engine art. Camshaft phaser 10 allows the timing between the crankshaft and camshaft 12 to be varied. In this way, opening and closing of the intake and/or exhaust valves can be advanced or retarded in order to achieve desired engine performance. In addition to camshaft phaser 10, the system includes camshaft phaser installation tool 16 which is used to prevent rotor 18 of camshaft phaser 10 and camshaft 12 from rotating while camshaft phaser attachment bolt 20 is being tightened to a predetermined torque.

Camshaft phaser 10 includes sprocket 22 which is driven by a chain or gear (not shown) driven by the crankshaft of internal combustion engine 14. Alternatively, sprocket 22 may be a pulley driven by a belt. Sprocket 22 includes a central bore 24 for receiving camshaft 12 coaxially therethrough which is allowed to rotate relative to sprocket 22. Sprocket 22 is sealingly secured to stator 26 with sprocket bolts 28 in a way that will be described in more detail later.

Stator 26 is generally cylindrical and includes a plurality of radial chambers 30 defined by a plurality of lobes 32 extending radially inward. In the embodiment shown, there are four lobes 32 defining four radial chambers 30, however, it is to be understood that a different number of lobes may be provided to define radial chambers equal in quantity to the number of lobes.

Rotor 18 includes central hub 34 with a plurality of vanes 36 extending radially outward therefrom and central through bore 38 extending axially therethrough. The number of vanes 36 is equal to the number of radial chambers 30 provided in stator 26. Rotor 18 is coaxially disposed within stator 26 such that each vane 36 divides each radial chamber 30 into advance chambers 40 and retard chambers 42. The radial tips of lobes 32 are mateable with central hub 34 in order to separate radial chambers 30 from each other. Preferably, each of the radial tips of vanes 36 includes one of a plurality of wiper seals 44 to substantially seal adjacent advance and retard chambers 40, 42 from each other. Although not shown, each of the radial tips of lobes 32 may include a wiper seal similar in configuration to wiper seal 44.

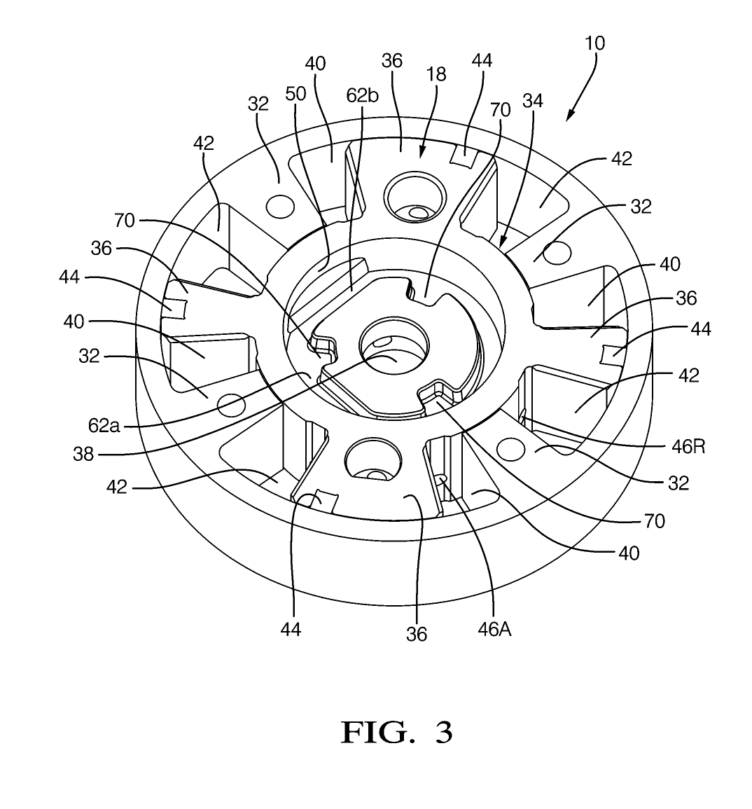

Central hub 34 includes a plurality of oil passages 46A, 46R formed radially therethrough (only one of each of oil passages 46A, 46R are visible in FIG. 3). Each one of the plurality of oil passages 46A is in fluid communication with one of the advance chambers 40 for supplying oil thereto and therefrom while each one of the plurality of oil passages 46R is in fluid communication with one of the retard chambers 42 for supplying oil thereto and therefrom. As is well known in the art of vane-type camshaft phasers, a valve (not shown) is used, in operation of camshaft phaser 10, to direct pressurized oil to one of the advance chambers 40 and retard chambers 42 while oil is vented from the other of the advance chambers 40 and retard chambers 42 in order to change the phase relationship between the camshaft and the crankshaft.

Bias spring 48, which is a helical torsion spring, is disposed within central opening 52 of camshaft phaser cover 54 and within annular pocket 50 formed in rotor 18. Central opening 52 provides access through camshaft phaser cover 54 to central hub 34 and is defined by semi-circular inner edge 56 and arcuate spring capture flange 58 extending radially inward from inner edge 56. Bias spring 48 is grounded at one end thereof to camshaft phaser cover 54 by grounding slot 60 which extends only part way axially into camshaft phaser cover 54. Bias spring 48 is attached at the other end thereof to rotor 18 by fitting within bias spring rotor grooves 62a, 62b which are substantially at a right angle to each other. Bias spring 48 also passes through cover bias spring groove 64 defined by spring capture flange 58 in order to provide mechanical advantage, in use, to bias spring 48. When pressurized oil is not supplied to any of the advance or retard chambers 40, 42, bias spring 48 urges rotor 18 to a predetermined angular position within stator 26.

Camshaft phaser cover 54 is sealingly attached to stator 26 by sprocket bolts 28 that extend through sprocket 22 and stator 26 and threadably engage camshaft phaser cover 54. In this way, stator 26 is secured between sprocket 22 and camshaft phaser cover 54 in order to axially and radially secure sprocket 22, stator 26, and camshaft phaser cover 54 to each other. Also in this way, advance and retard chambers 40, 42 are sealed axially between sprocket 22 and camshaft phaser cover 54.

Camshaft phaser 10 is angularly indexed to camshaft 12 using indexing slot 66 formed in the axial end of camshaft 12 and indexing pin 68 extending from rotor 18. In this way, angular alignment between rotor 18 and camshaft 12 is achieved and after camshaft phaser attachment bolt 20 is tightened to the predetermined torque, relative rotation between camshaft 12 and rotor 18 is prevented.

In order to tighten camshaft phaser attachment bolt 20 to the predetermined torque, camshaft 12 and rotor 18 must be prevented from rotating by applying an opposing torque equal in magnitude but in a direction opposite of the predetermined torque. The opposing torque is applied to rotor 18 with camshaft phaser installation tool 16. In order to apply the opposing torque, central hub 34 is provided with a plurality of angularly spaced notches 70 that extend axially thereinto. One of the plurality of notches 70 may be positioned between first and second bias spring grooves 62a, 62b and the plurality of notches 70 may be spaced equiangularly. Notches 70 may be arranged such that no one of the notches 70 diametrically opposes any of the other notches 70. Camshaft phaser installation tool includes handle 72 having head 74 which is sized to be inserted through central opening 52 of camshaft phaser cover 54. Tangs 76 extend axially away from head 74 and are sized to interfit closely with notches 70 of central hub 34.

Head 74 of camshaft installation tool 16 includes a substantially cylindrical passage 78 extending therethrough to allow access to camshaft phaser attachment bolt 20 by driving tool 80. Driving tool 80 has features complementary to camshaft phaser attachment bolt 20 to allow application of the predetermined torque thereto. Driving tool 80 may be connected to a power driver or a hand wrench (not shown) which is used to produce the force for tightening camshaft phasers attachment bolt 20 to the predetermined torque. Head 74 also includes recess 82 on the outer periphery thereof. Recess 82 provides clearance relative to spring capture flange 58.

When camshaft phaser 10 is to be attached to camshaft 12, camshaft phaser 10 is aligned coaxially with camshaft 12 such that indexing slot 66 is aligned with indexing pin 68. Camshaft phaser 10 is then moved axially toward camshaft 12 until camshaft 12 passes through central bore 24 of sprocket 22 and rotor 18 comes into contact with camshaft 12. Camshaft attachment bolt may be inserted through central opening 52 of camshaft phaser cover 54 and central through bore 38 of rotor 18 and threadably engaged with camshaft 12. Head 74 of camshaft phaser installation tool 16 may be inserted axially through central opening 52 of camshaft phaser cover 54 by aligning recess 82 with spring capture flange 58. Camshaft phaser installation tool 16 is moved axially until tangs 76 of head 74 interfit with notches 70 of central hub 34. Driving tool 80 is engaged with camshaft phaser attachment bolt 20 through cylindrical passage 78 and torque is applied by driving tool 80 to camshaft phaser attachment bolt 20. Camshaft phaser installation tool 16 is held substantially stationary to resist the torque of driving tool 80, thereby preventing rotation of rotor 18 and camshaft 12. When camshaft phaser attachment bolt 20 has been tightened to the predetermined torque, driving tool 80 is disengaged from camshaft phaser attachment bolt 20 and camshaft phaser installation tool 16 is removed from central opening 52.

While notches 70 have been represented in the figures as concave recesses in rotor 18, it should now be understood that the notches may also be convex protrusions or a combination of concave recesses and convex protrusions. Similarly, while tangs 76 have been represented in the figures as convex protrusions, it should now be understood that the tangs may also be concave recesses or a combination of convex protrusions and concave recesses.

While the head of camshaft phaser attachment bolt 20 has been illustrated as an external Torx® arrangement, it should now be understood that other arrangements may be used such as internal Torx® arrangement, internal hex, external hex, or any other drive arrangement known in the threaded fastener art. Similarly, driving tool 80 may be arranged to engage whichever drive arrangement is chosen for the head of camshaft phaser attachment bolt 20.

While this invention has been described in terms of preferred embodiments thereof, it is not intended to be so limited, but rather only to the extent set forth in the claims that follow.

We claim:

1. A camshaft phaser attachment system comprising:
a camshaft phaser for controllably varying the phase relationship between a crankshaft and a camshaft in an internal combustion engine, said camshaft phaser comprising:
a stator attached to said engine crankshaft to provide a fixed ratio of rotation between said stator and said crankshaft;
a rotor having a central hub, said rotor being coaxially disposed within said stator so as to form an array of pressurized oil chambers used to vary the phase relationship between said crankshaft and said camshaft, said rotor being attachable at said central hub to said camshaft of said internal combustion engine to prevent relative rotation between said rotor and said camshaft, said central hub having a plurality of angularly spaced notches therein;
a camshaft phaser attachment bolt extending coaxially through said central hub to threadably engage said camshaft to clamp said rotor to said camshaft;
a camshaft phaser cover engageable with said stator to seal one side of said pressurized oil chambers and having a central opening to provide access to said central hub, said central opening being defined by a semi-circular inner edge and an arcuate spring capture flange extending radially inwardly from said inner edge; and
a helical bias spring contained axially between said camshaft phaser cover capture flange and said rotor to bias said rotor to a predetermined position when pressurized oil is not supplied to said pressurized oil chambers;
said camshaft phaser attachment system also comprising a camshaft phaser installation tool comprising:
a handle with a head sized to be inserted through said central opening of said camshaft cover and to be held substantially stationary while said camshaft phaser attachment bolt is being tightened to said predetermined torque, said head having a recess in the outer periphery to provide clearance relative to said spring capture flange and a plurality of tangs sized to interfit closely with said notches and prevent relative rotation with said rotor; and
a substantially cylindrical central passage through said head of said handle to allow a tightening tool to reach said camshaft attachment bolt for tightening said camshaft phaser attachment bolt to said predetermined torque.

2. A camshaft phaser attachment system in accordance with claim 1 wherein said each of said notches do not diametrically oppose each other.

3. A camshaft phaser attachment system in accordance with claim 2 wherein said notches are spaced equiangularly.

4. A camshaft phaser attachment system in accordance with claim 1 wherein said notches are located between said rotor and said camshaft phaser cover.

5. A camshaft phaser attachment system in accordance with claim 1 wherein said capture flange defines a first groove for receiving a first portion of said biasing spring.

6. A camshaft phaser attachment system in accordance with claim 1 wherein said central hub includes a second groove between an adjacent pair of said notches for receiving a second portion of said biasing spring.

7. A camshaft phaser attachment system comprising:
a camshaft phaser for controllably varying the phase relationship between a crankshaft and a camshaft in an internal combustion engine, said camshaft phaser comprising:
a stator attached to said engine crankshaft to provide a fixed ratio of rotation between said stator and said crankshaft;
a rotor having a central hub, said rotor being coaxially disposed within said stator so as to form an array of pressurized oil chambers used to vary the phase relationship between said crankshaft and said camshaft, said rotor being attachable at said central hub to said camshaft of said internal combustion engine to prevent relative rotation between said rotor and said camshaft, said central hub having a plurality of angularly spaced notches therein;
a camshaft phaser attachment bolt extending coaxially through said central hub to threadably engage said camshaft to clamp said rotor to said camshaft;
a camshaft phaser cover engageable with said stator to seal one side of said pressurized oil chambers and having a central opening to provide access to said central hub, said central opening being defined by a semi-circular inner edge and an arcuate spring capture flange extending radially inwardly from said inner edge; and
a helical bias spring contained axially between said camshaft phaser cover capture flange and said rotor to bias said rotor to a predetermined position when pressurized oil is not supplied to said pressurized oil chambers.

8. A camshaft phaser attachment system in accordance with claim 7 wherein said each of said notches do not diametrically oppose each other.

9. A camshaft phaser attachment system in accordance with claim 8 wherein said notches are spaced equiangularly.

10. A camshaft phaser attachment system in accordance with claim 9 wherein said notches are located between said rotor and said camshaft phaser cover.

11. A camshaft phaser attachment system in accordance with claim 7 wherein said capture flange defines a first groove for receiving a first portion of said biasing spring.

12. A camshaft phaser attachment system in accordance with claim 7 wherein said central hub includes a second groove between an adjacent pair of said notches for receiving a second portion of said biasing spring.

13. A camshaft phaser attachment system comprising:
a camshaft phaser installation tool comprising:
a handle with a head sized to be inserted through a central opening of a camshaft cover of a camshaft phaser and to be held substantially stationary while a camshaft phaser attachment bolt is being tightened to a predetermined torque, said head having a recess in the outer periphery to provide clearance relative to a spring capture flange and a plurality of tangs sized to interfit closely with a plurality of notches in a rotor of said camshaft phaser to prevent relative rotation with said rotor; and
a substantially cylindrical central passage through said head of said handle to allow a tightening tool to reach said camshaft attachment bolt for tightening said camshaft attachment bolt to said predetermined torque.

14. A camshaft phaser attachment system in accordance with claim 13 wherein said tangs extend axially away from said head.
